(19) United States
(12) Patent Application Publication
(10) Pub. No.: US 2025/0286734 A1
(43) Pub. Date: Sep. 11, 2025

(54) ACCESS CONTROL OF ELECTRONIC DEVICE FEATURE USING A CERTIFICATE

(71) Applicant: HEWLETT PACKARD ENTERPRISE DEVELOPMENT LP, Spring, TX (US)

(72) Inventors: Lee A. Preimesberger, Houston, TX (US); Vartan Yosef Kasheshian, Houston, TX (US); Grant Tavis O'Connor, Spring, TX (US)

(21) Appl. No.: 18/596,925

(22) Filed: Mar. 6, 2024

(51) Int. Cl. H04L 9/32; G06F 21/62

(52) U.S. Cl. CPC H04L 9/3268; G06F 21/629; H04L 9/3247; G06F 2221/2141

(57) ABSTRACT

In some examples, a controller of an electronic device receives a certificate sent from an access device that is connected to the electronic device, the certificate including a feature control information element that provides access control of an electronic device feature of the electronic device, the certificate issued by a certificate authority, where the electronic device feature of the electronic device is initially blocked from access. The controller validates the certificate using the representation of the security key hierarchy in the memory. Responsive to the validation of the certificate, the controller enables access to the electronic device feature by the access device based on the feature control information element in the certificate.

### BACKGROUND

Electronic devices can be deployed in computing environments such as data centers, cloud computing environments, or other computing environments. During the life of an electronic device, different people may have physical access to the electronic device, such as at a manufacturing or assembly site, during shipment of the electronic device to a target destination, and during use of the electronic device at the target destination.

### BRIEF DESCRIPTION OF THE DRAWINGS

Some implementations of the present disclosure are described with respect to the following figures.

FIG. 1 is a block diagram of an arrangement that includes a server computer, an access device, and a public key infrastructure (PKI) including a certificate authority (CA), in accordance with some examples.

FIG. 2 is a block diagram of a process of certificate-based fine-grained access control of electronic device features of the server computer, according to some examples.

FIG. 3 is a block diagram depicting delegation of access permissions among users, according to some examples.

FIG. 4 is a block diagram of a PKI tree according to some examples.

FIG. 5 is a block diagram of an electronic device according to some examples.

FIG. 6 is a block diagram of a storage medium storing machine-readable instructions according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Although security mechanisms and techniques have been implemented to protect programs and network communications of electronic devices, some electronic devices may still be subject to unauthorized physical access. Outside of tightly controlled physical facilities, electronic devices may be accessed at a manufacturing or assembly site, during shipment, after hours, or at remote sites (such as when a user is traveling or at any sites that are away from secure areas of an enterprise). In some cases, electronic devices of a first enterprise may be physically located at a colocation data center operated by a second enterprise. The second enterprise may rent physical space in the colocation data center for the electronic devices of the first enterprise.

An unauthorized user (e.g., a technician or any other user) may be able to connect (either using a wired connection or a wireless connection) portable devices to a target electronic device to obtain sensitive information from the target electronic device, including network addresses such as Internet Protocol (IP) addresses, user credentials, versions of programs in the target electronic device, and/or other sensitive information. The portable device once connected to the target electronic device may even be able to capture user inputs (e.g., inputs to a keyboard or touchscreen, pointer device inputs, etc.) entered by a user on a remote console that is coupled over a network to the target electronic device. Further, the portable device may be able to introduce malware into the target electronic device to corrupt the target electronic device or to cause the target electronic device to perform unauthorized actions. An example of a portable device that can be connected to the target electronic device is a Universal Serial Bus (USB) device. Other types of portable devices include smartphones, tablet computers, notebook computers, or any other electronic device that can be carried by a user to the location of the target electronic device.

In accordance with some implementations of the present disclosure, a security key hierarchy (including a hierarchical arrangement of keys) is bound to a target electronic device (or more generally, to a collection of target electronic devices) that is to be protected against unauthorized physical access. As used here, a “collection” of items can refer to a single item or multiple items. Thus, a collection of target electronic devices can refer to a single target electronic device or multiple target electronic devices. An example of the security key hierarchy is a public key infrastructure (PKI) tree that has a hierarchical arrangement of keys representing entities of an enterprise. To bind the security key hierarchy to the target electronic device that is to be protected, a representation of the security key hierarchy is provided to a controller in the target electronic device to be protected. The controller can include a management controller such as a baseboard management controller (BMC). Certificates can be generated based on keys in the security key hierarchy to provide access control of certain features of a target electronic device. A certificate can include access control metadata that supports fine-grained access control of specific features of the target electronic device.

A “fine-grained” access control of a feature of the target electronic device refers to the ability to selectively enable or disable access to the feature by an access device. The fine-grained access control is distinguished from device-level access control in which overall access to the target electronic device is enabled or disabled. The fine-grained access control based on access control metadata of a certificate allows access to be disabled for a first feature of the target electronic device while access to a second feature of the target electronic device is enabled.

An enterprise can refer to an organization (e.g., a business concern, a government agency, an educational organization, a charitable organization, or any other organization) or an individual. Entities of the enterprise can include users (e.g., employees, contractors, personnel of third-party vendors, or other users) of the enterprise, segments of the enterprise (e.g., different departments of an organization), access devices that are to be used to access target electronic devices, or other types of entities. The security key hierarchy includes keys associated with respective entities associated with the enterprise. A key associated with an access device is used to provide fine grained access control of a target electronic device that is bound to the security key hierarchy. More specifically, the key associated with the access device can be used to obtain a security certificate (or more simply, a “certificate”) that includes access control metadata that can selectively control access to individual features of the target electronic device, such as a port (e.g., a USB port or another type of wired or wireless port) of the target electronic device, a display device of the target electronic device, a power cycling subsystem of the target electronic device (which controls power cycling of the target electronic device), a program of the target electronic device, a boot mechanism to boot the target electronic device, or any other feature.

Examples of electronic devices to be protected against unauthorized physical access can include computers such as server computers, desktop computers, notebook computers and tablet computers; storage systems; communication nodes; vehicles; or other types of electronic devices. Examples of access devices can include notebook computers, tablet computers, smartphones, USB devices, or other types of devices that when connected (by a wired connection or a wireless connection) to a target electronic device enables a user to access the target electronic device.

A “key” can refer to a collection of values (a single value or multiple values) that can be used to obtain a certificate to support secure access to a target electronic device. In some examples, a key can refer to a public-private key pair that includes a public key and the associated private key.

A “certificate” can refer to information that is used to secure communications, such as between an access device and a target electronic device. In some examples, certificates can be X.509 certificates according to the X.509 protocol, which is provided by the International Telecommunication Union (ITU) and defines the format of public key certificates. An X.509 certificate binds an identity to a public key using a digital signature. A certificate contains an identity (a hostname, or an identity of an organization or an individual) and a public key, and the certificate can be signed by a certificate authority (CA). When a certificate is signed by a trusted CA, an entity holding the certificate can use the public key contained in the certificate to establish secure communications with another entity, such as to ensure that an access device that is connected to a target electronic device is authorized to access features of the target electronic device.

In accordance with some implementations of the present disclosure, a certificate such as an X.509 certificate is extended to add access control metadata, which can be in the form of object identifier (OID) metadata according to X.509, for example. The access control metadata can include one or more feature control information elements (in the form of values of OIDs, for example) that specify access permissions of electronic device features. A feature control information element if set to a first value disables access disables access to an electronic device feature of a target electronic device, and if set to a different second value enables access to an electronic device feature of a target electronic device.

More specifically, an X.509 certificate includes an Extensions field, which is a sequence of one or more certificate extensions. Each certificate extension has its own unique identifier, expressed as an OID. An OID includes a set of values. In some examples of the present disclosure, one or more values of an OID can be used as a feature control information element (or more generally, access control metadata) to control access to an electronic device feature.

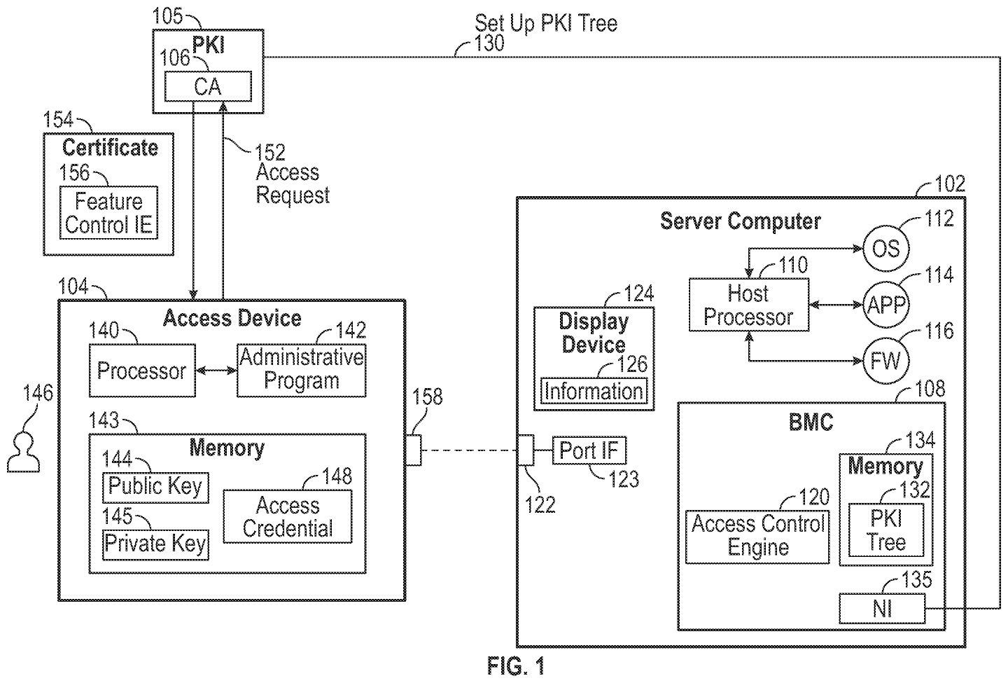

FIG. 1 is a block diagram of an example arrangement that includes a server computer 102, an access device 104, and a public key infrastructure (PKI) 105. The server computer 102 is an example of a target electronic device with electronic device features that are to be selectively enabled or disabled using certificates according to some examples of the present disclosure.

The PKI 105 is an example of a system (implemented with one or more computers) that manages the issuance of certificates and the binding of target electronic devices, such as the server computer 102, to a security key hierarchy (e.g., a PKI tree), to enable selective access control of electronic device features. The PKI 105 includes a certificate authority (CA) 106 that issues certificates.

Although just one server computer 102 and one access device 104 is depicted in FIG. 1, it is noted that there may be multiple server computers or other target electronic devices and multiple access devices. For example, a facility can include a large quantity of target electronic devices. Users with access devices can attempt to access electronic device features of the target electronic devices.

The server computer 102 includes a baseboard management controller (BMC) 108 and a host processor (or multiple host processors) 110. The BMC 108 is an example of a management controller of the server computer 102 that is able to perform management tasks associated with the server computer 102.

The host processor 110 is part of the processing resource of the server computer 102. The host processor 110 executes primary machine-readable instructions of the server computer 102, such as an operating system (OS) 112, an application program 114, system firmware 116, or other software or firmware. A processor can include a microprocessor, a core of a multi-core microprocessor, a microcontroller, a programmable integrated circuit, a programmable gate array, or another hardware processing circuit.

The system firmware 116 can include Basic Input/Output System (BIOS) code or Universal Extensible Firmware Interface (UEFI) code, for example. “Primary” machine-readable instructions are distinct (and separate) from machine-readable instructions (such as firmware or software) executable by other electronic components (separate from the host processor 110). The primary machine-readable instructions may be stored in a storage medium (not shown in FIG. 1)

As used here, a “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on one or more hardware processing circuits.

The server computer 102 includes various electronic device features. An access control engine 120 of the BMC 108 can selectively enable or disable access to the electronic device features based on a certificate presented to the BMC 108, such as from the access device 104. As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

The access control engine 120 can control fine-grained access control of the electronic device features, which can include a port 122 of the server computer 102, a display device 124 of the server computer 102, a power cycling subsystem of the server computer 102 (that can power off the server computer 102 followed by powering on the server computer 102), a boot mechanism to boot the server computer 102, and/or other features. An example of the port 122 is a USB port. In other examples, different types of ports may be employed. A “port” refers to an interface of an electronic device that is accessible by an external device (e.g., the access device 104) to gain access to the electronic device. The port may perform wired or wireless communication with the external device. A port interface (IF) 123 is connected to the port 122 to communicate with the external device when the external device is connected to the port 122. If access to the port 122 is disabled, then an external device such as the access device 104 would not be able to access portions of the server computer 102 through the port 122. For example, the external device would not be able to access stored information in the server computer 102, access programs or hardware components in the server computer 102, monitor inputs from remote consoles that are coupled to the server computer 102, and so forth.

As shown in FIG. 1, the display device 124 can display information 126. In some cases, the information 126 displayed by the display device 124 of the server computer 102 may include sensitive information that should not be viewed by an unauthorized user. If access to the display device 124 is disabled, then the display device 124 may show a blank screen or may just show generic information that is not sensitive.

In some examples, the electronic device features of the server computer 102 are initially locked from access unless access to the electronic device features are enabled by the access control engine 120 of the BMC 108. Effectively, the server computer 102 may be initially a “bricked” device, which refers to a device that is non-functional, due to the electronic device features being disabled. The locking of the electronic device features can be performed by a manufacturer of the server computer 102, or by an administrator at a facility in which the server computer 102 is located, or by any other designated entity. While locked, no person can gain access to the server computer 102 without a certificate.

Access to the port 122 can be disabled (or locked) by shutting down the port IF 123 or configuring the port IF 123 (or alternatively, the host processor 110) to be non-responsive to signals from an external device connected to the port 122. Access to the display device 124 is disabled by configuring by shutting down the display device 124 or configuring a program or hardware component associated with the display device to prevent display of any information, or to allow display of just generic information. Access to a power cycling subsystem of the server computer 102 can be disabled by blocking access to a power controller in the server computer 102. The boot mechanism of the server computer 102 can be disabled by preventing a bootloader from being loaded in the server computer 102.

The CA 106 is a trusted third-party that can be used to produce certificates that can allow entities, such as the access device 104, to access electronic device features of the server computer 102 (and other target electronic devices).

The PKI 105 can set up (at 130) a PKI tree 132 in the BMC 108. The PKI tree 132 is stored in a memory 134 of the BMC 108. The BMC 108 includes a network interface (NI) 135 that is connected to a management network. The PKI 105 can interact with the BMC 108 over the management network. The management network is a secondary network to which the server computer 102 is connected. The server computer 102 can include a network interface (not shown) that is connected to a primary network separate form the management network. The primary network is used by the server computer 102 to perform communications associated with normal operations of the server computer 102, such as operations performed by the primary machine-readable instructions of the server computer 102. “Normal” operations can refer to operations of the server computer 102 that are different from management operations of a management controller such as the BMC 108.

Setting up the PKI tree 132 in the BMC 108 binds the PKI tree 132 to the server computer 102. Once the PKI tree 132 is installed in the BMC 108, the access control engine 120 can selectively enable or disable access to electronic device features of the server computer 102 based on certificates provided to the BMC 108 by external entities, such as the access device 104. The certificates can be generated by the CA 106 based on keys that are represented in the PKI tree 132.

The PKI tree 132 includes a hierarchical arrangement of nodes that represent different entities, including users, user groups, access devices, or other entities. Each node is associated with a key that is assigned to the entity. A key in the PKI tree 132 can include a public-private key pair that has a public key and the corresponding private key.

The access device 104 includes a processor 140 (or multiple processors) and a memory 143. The processor 140 can execute an administrative program 142 that is used to perform various administrative tasks with respect to the server computer 102, such as to perform maintenance, troubleshooting, repairs (including updates of machine-readable instructions of the server computer 102), and so forth. The memory 143 stores a public key 144 that is associated with the access device 104. The memory 143 can also store a private key 145 that is associated with the public key 144. The memory 143can be a secure memory that is part of a security processor of the access device 104. An example of a security processor is a trusted platform module (TPM).

The access device 104 is used by a user 146, which may be a technician or another type of user. Note that the public key 144 and the private key 145 can be keys assigned to the user 146, to allow the user 146 to use the access device 104 to obtain a certificate 154 to gain access to electronic device features of the server computer 102.

The memory 143 also stores an access credential 148, such as a password, a personal identification number (PIN), biometric information, or any other credential that can be provided by the user 146 to gain access to the access device 104. For example, to gain access to the access device 104, the user 146 can enter a password or a PIN using an input device of the access device 104. Alternatively, the access device 104 is able to receive biometric information of the user 146, such as based on a camera performing facial recognition or a fingerprint scanner scanning a fingerprint of the user 146.

If the user 146 wishes to access electronic device features (including the port 122 and/or the display device 124) of the server computer 102, in addition to inputting an access credential (to be matched to the stored access credential 148), the user 146 also uses the access device 104 to obtain a certificate that is to be provided to the BMC 108 of the server computer 102. In accordance with some examples of the present disclosure, the access device 104 constitutes a multifactor access device that allows the user 146 to access an electronic device feature of the server computer 102 based on multiple factors, including the access credential 148 and use of a certificate derived from the public key 144 stored in the access device 104.

In other examples, the user 146 does not have to be physically near the access device 104. The user 146 may be remotely located from the access device 104, but the user 146 may have another device that has wireless connectivity, such as over a WI-FI network or a cellular network, to the access device 104. The remote user 146 can perform remote administration of the server computer 102 using the access device 104, based on obtaining the certificate 154 from the CA 106 as discussed above.

### Certificate-Based Fine-Grained Access Control

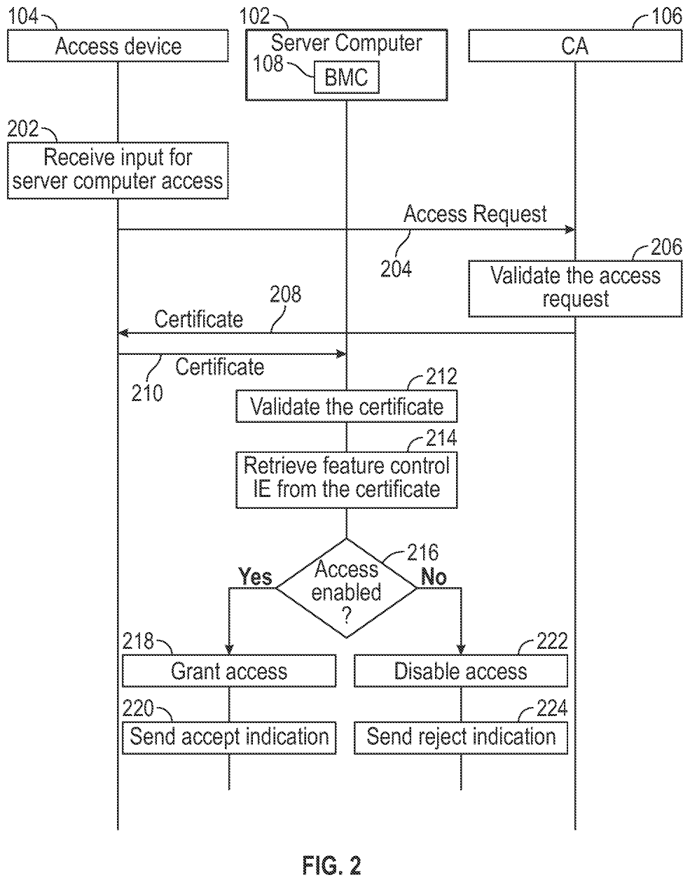

The following discussion refers to both FIG. 1 and FIG. 2. FIG. 2 is a flow diagram of a process of providing certificate-based fine-grained access control to electronic device features of the server computer 102, in accordance with some examples of the present disclosure. In other examples, the tasks of the process can be performed in a different order from that depicted in FIG. 2, additional tasks may be added, and some tasks may be omitted.

To obtain a certificate, the user 146 can provide an input to the access device 104, such as through a user interface (UI) of the access device 104. The administrative program 142 receives (at 202) the input for server computer access. In response to the input, the administrative program 142 sends (at 204) an access request 152 to the CA 106 over a network. The access request 152 can include a certificate signing request (CSR), which is a request that seeks the issuance of a certificate. The CSR can contain the public key 144 of the access device 104.

In response to the CSR, the CA 106 validates (at 206) the access request. For example, the CSR may be signed by the access device 104 using the private key 145. The CA 106 is able to successfully validate the CSR if the CSR is signed using a valid private key. In response to successful validation of the CSR, the CA 106 issues a certificate 154 that is sent (at 208) from the CA 106 back to the access device 104. In accordance with some examples of the present disclosure, the CA 106 includes a feature control information element (IE) 156 in the certificate 154. The feature control information element 156 may be part of an OID of the certificate 154 (e.g., an X.509 certificate), for example. The feature control information element 156 can be set to one of several different values, which can specify whether or not the access device 104 is able to access a corresponding electronic device feature of the server computer 102 once the access device 104 is connected to the server computer 102 (e.g., a port 158 of the access device 104 is connected to the port 122 of the server computer 102). In some cases, the certificate 154 can include multiple feature control information elements that correspond to different electronic device features of the server computer 102.

Fine-grained access control based on feature control information elements of a certificate can be accomplished without the BMC 108 having to access a remote device to verify whether access should be granted. For example, even if the BMC 108 were to lose a network connection, fine-grained access control based on the certificate 154 presented by the access device 104 can still be performed.

To request access to one or more electronic device features of the server computer 102, the administrative program 142 can send (at 210), to the BMC 108, the certificate 154, such as through the port 122 of the server computer 102 or through another connection to the server computer 102. The other connection may be an out-of-band connection to the NI 135 of the BMC 108, for example. Note that the connection between the access device 104 and the BMC 108 is a zero trust connection; in other words, just because the access device 104 is able to connect to the BMC 108 does not mean that the access device 104 can be trusted. Rather, the trust is established using the certificate 154.

The access control engine 120 receives the certificate 154 from the access device 104. Based on the certificate 154, the access control engine 120 can determine whether or not to grant access to one or more of the electronic device features of the server computer 102 to the access device 104.

In some examples, the certificate 154 sent from the access device 104 to the BMC 108 is signed using the private key 145 of the access device 104. The access control engine 120 can validate (at 212) the certificate 154, such as by using the public key of the access device 104 to decrypt the signed certificate 154. The public key of the access device 104 can be obtained by the access control engine 120 from the PKI tree 132.

In some examples, in addition to presenting the certificate 154, the administrative program 142 in the access device 104 can further send, to the BMC 108, a message (e.g., a data packet) that contains a current timestamp (from a time clock in the access device 104). The message containing the current timestamp is signed by the private key 145 of the access device 104. A reason to send the message containing the current timestamp signed with the private key 145 is to prevent a replay attack in which an unauthorized entity that has obtained the certificate can replay the same certificate repeatedly to gain access to the server computer 102. The current timestamp serves as an indication to the access control engine 120 in the BMC 108 that the signed certificate is not too old. In other examples, the access control engine 120 can issue a challenge to the access device 104 to avoid a replay attack. The validation of the certificate 154 is thus further based on validating the message containing the current timestamp, or receiving a valid response to the challenge issued by the access control engine 120 to the access device 104.

If the access control engine 120 is able to successfully validate the certificate 154 from the access device 104, the access control engine 120 retrieves (at 214) the feature control information element 156 from the certificate 154, and determines (at 216), based on the value assigned the feature control information element 156 in the certificate 154, whether a corresponding electronic device feature of the server computer 102 is to be enabled or disabled.

If the value assigned the feature control information element 156 in the certificate 154 specifies that access to the corresponding electronic device feature is enabled, the access control engine 120 grants access (at 218) to the corresponding electronic device feature. The access control engine 120 can send (at 220) an accept indication to the access device 104, where the accept indication can indicate that access to the corresponding electronic device feature has been granted. The accept indication can include a message, an information element, a signal, or any other indicator. For example, the accept indication can be in the form of the corresponding electronic device feature responding positively to the access attempt by the access device 104 (e.g., by allowing the access device 104 to access the corresponding electronic device feature).

If the value assigned the feature control information element 156 in the certificate 154 specifies that access to the corresponding electronic device feature is disabled, the access control engine 120 disables access (at 222) to the corresponding electronic device feature. The access control engine 120 can send (at 224) a reject indication to the access device 104, where the reject indication can indicate that access to the corresponding electronic device feature has been denied. The reject indication can include a message, an information element, a signal, or any other indicator. For example, the reject indication can be in the form of the server computer 102 responding with an error or not responding at all to the access attempt by the access device 104.

In some examples, the certificate 154 can have multiple feature control information elements 156, including a first feature control information element for the port 122 and a second feature control information element for the display device 124. The first feature control information element can specify whether access to the port 122 is enabled (or disabled), and the second feature control information element can specify whether access to the display device 124 is enabled (or disabled).

If a feature control information element of the certificate 154 specifies that access to a respective electronic device feature is enabled, the access control engine 120 provides an indication to an entity (e.g., the host processor 110 or a program executed by the host processor 110) that access to the respective electronic device feature is enabled, so the entity can configure the respective electronic device feature to enable the access.

On the other hand, if the feature control information element of the certificate 154 specifies that access to the respective electronic device feature is disabled, the access control engine 120 can keep the respective electronic device feature in an access disabled state. Note that in some examples, the electronic device features of the server computer 102 are initially locked from access, such that the electronic device features cannot be accessed absent provision of a valid certificate from an access device.

In some examples, a certificate, such as the certificate 154, has an expiry time, after which the certificate is no longer valid. For example, the certificate 154 may include an expiry time information element that specifies either a time duration from an issue time of the certificate 154 after which the certificate 154 is considered expired, or a set time at which the certificate 154 is considered expired. Once a certificate is expired, a user or access device would no longer be able to use the expired certificate to access an electronic device feature of the server computer 102. The time duration during which a certificate is valid can be on the order of hours, days, months, or other time lengths.

The PKI 105 can revoke an issued certificate at any point in time. For example, the PKI 105 can distribute a certificate revocation list to the server computer 102 (and to other target electronic devices) that includes identifiers of certificates that have been revoked. The access control engine 120 can check the certificate revocation list before validating a certificate. If the certificate is identified in the certificate revocation list, then the access control engine 120 can reject the attempted access to the electronic device feature. Note that when a given certificate is revoked, any certificates that depend from the given certificate are also revoked (e.g., a certificate of a department head being revoked would revoke the certificates of the entire department).

### Access Rights Delegation

An enterprise, such as the enterprise that operates or manages a collection of server computers and/or other electronic devices, may include a number of users. In accordance with some examples of the present disclosure, different users (or different groups of users) may be assigned different access roles with respect to accessing electronic devices of the enterprise.

For example, a first class of user is an executive user (or “superuser”), who is assigned the highest access role (a role with the greatest access rights to electronic devices). The executive user (such as a system administrator for the enterprise) may be granted a highest level of access to electronic devices. In addition, the executive user may be able to delegate rights to other classes of users with lesser access roles (roles with decreased access rights to electronic devices).

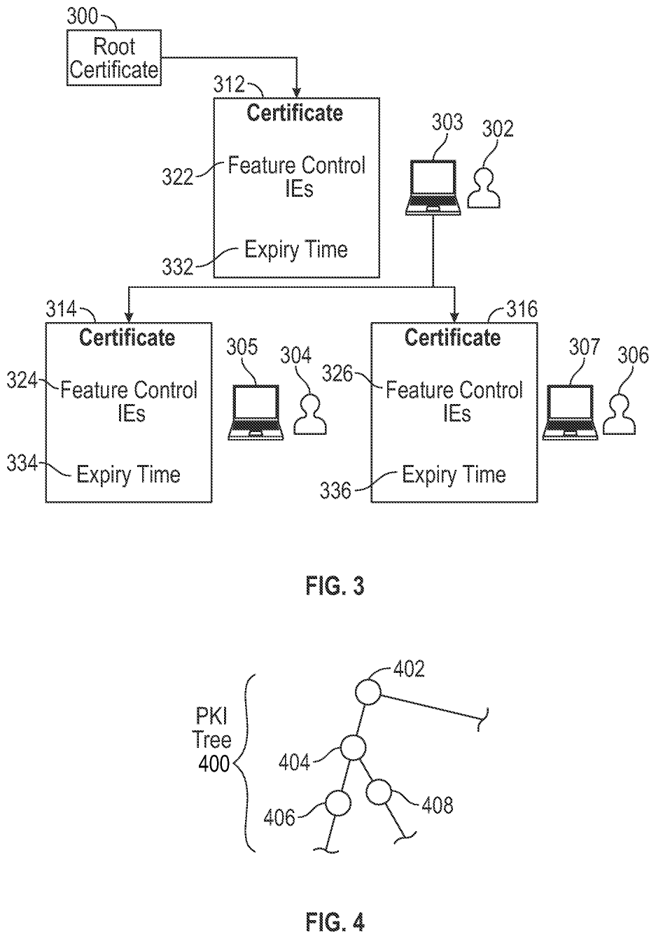

The following discussion refers to FIG. 3 and FIG. 4. FIG. 3 is a block diagram illustrating different classes of users, including an executive user 302, a programmer 304, and a technician 306. FIG. 4 is a block diagram of a PKI tree 400, which can be an example of the PKI tree 132 of FIG. 1.

The executive user 302 has a user device 303, the programmer 304 has a user device 305, and the technician 306 has a user device 307. A “user device” can refer to a computer or any other type of electronic device used by a user.

An enterprise that the users are part of includes a root certificate 300. The root certificate 300 is represented by the root 402 of the PKI tree 400. Note that the root certificate 300 can correspond to the overall enterprise, and thus the root 402 of the PKI tree 400 can represent the enterprise.

One or more lower level nodes in the PKI tree 400 can depend from the root 402. For example, a node 404 depends from the root 402, and the node 404 can represent the executive user 302. In some examples, the executive user 302 can delegate access rights to the programmer 304 and the technician 306. The programmer 304 is represented by a node 406 that depends from the node 404, and the technician 306 is represented by a node 408 that depends from the node 404. Other nodes in the PKI tree 400 can represent other users. Nodes of the PKI tree 400 can also represent departments or other groups within the enterprise. Additionally, nodes of the PKI tree 400 can represent devices and other resources, such as electronic devices that are to be protected.

A certificate 312 can be issued to the user 302, and the certificate 312 can be stored in the user device 303 associated with the user 302. The certificate 312 can be signed using a private key associated with the root certificate. The signed root certificate forms the certificate 312 that is issued to the user 302. The certificate 312 can include feature control information elements 322 (e.g., OID values of an X.509 certificate) that can specify a first collection of access permissions to access electronic device features of target electronic devices. In some examples, the certificate 312 can have a relatively long expiry time 332, which may be one year or some other time length.

The executive user 302 can in turn delegate subsets of the first collection of access permissions to other users, including the programmer 304 and the technician 306. For example, the programmer 304 can cause the user device 305 to send a CSR containing the programmer's public key to the user device 303 of the executive user 302. The user device 303 can include a CA that can respond to the CSR from the user device 305 by sending a certificate 314 containing feature control information elements 324 specifying a second collection of access permissions, which may be a first subset of the first collection of access permissions specified in the certificate 312 for the executive user 302. The certificate 314 for the programmer 304 can have an expiry time 334, which can be relatively short (e.g., a few days or another time length).

The technician 306 can cause the user device 307 to send a CSR containing the technician's public key to the user device 303 of the executive user 302. The CA in the user device 303 can respond to the CSR from the user device 307 by sending a certificate 316 containing feature control information elements 326 specifying a third collection of access permissions, which may be a second subset of the first collection of access permissions specified in the certificate 312 for the executive user 302. The third collection of access permissions may be the same as or different from the second collection of access permissions. The certificate 316 for the technician 306 can have an expiry time 336, which can be relatively short (e.g., a few hours or another time length). Note that the programmer 304 and the technician 306 do not have the ability to delegate access rights to other users.

In further examples, other users besides the executive user 302 can delegate access rights to further users.

### Further Examples

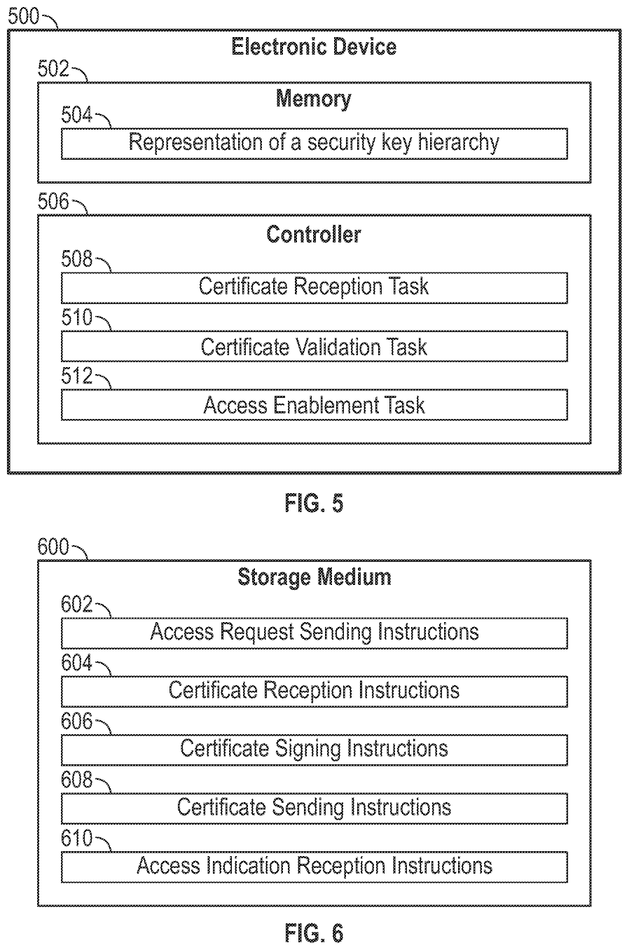

FIG. 5 is a block diagram of an electronic device 500 that is to be protected using techniques or mechanisms according to some examples of the present disclosure. An example of the electronic device 500 is the server computer 102 of FIG. 1.

The electronic device 500 includes a memory 502 to store a representation of a security key hierarchy 504. An example of the security key hierarchy is a PKI tree. Storing the representation of a security key hierarchy 504 in the electronic device 500 binds the security key hierarchy to the electronic device 500, so that certificate-based fine-grained access control can be used to selectively control electronic device features of the electronic device 500.

The electronic device 500 a controller 506, which can be a BMC or another type of management controller. The controller 506 can perform various tasks.

The tasks of the controller 506 include a certificate reception task 508 to receive a certificate sent from an access device (e.g., 104 in FIG. 1) that is connected to the electronic device 500. The certificate includes a feature control information element that provides access control of an electronic device feature of the electronic device 500. The certificate issued by a CA, and the electronic device feature of the electronic device is initially blocked from access.

The tasks of the controller 506 include a certificate validation task 510 to validate the certificate using the representation of the security key hierarchy in the memory. For example, the certificate may be signed by a private key stored in the access device. The validation of the signed certificate uses a public key retrieved from the representation of a security key hierarchy 504. For example, the retrieved public key is the public key associated with the access device (or the user of the access device) as represented by a node in the security key hierarchy.

The tasks of the controller 506 include an access enablement task 512 to, responsive to the validation of the certificate, enable access to the electronic device feature by the access device based on the feature control information element in the certificate. In some examples, the feature control information element is part of an OID in the certificate.

In some examples, the OID includes metadata in which the feature control information element is settable to different values to indicate whether the electronic device feature is accessible.

In some examples, the electronic device feature remains blocked from access in an absence of a valid certificate.

In some examples, the electronic device feature includes a communication port of the electronic device, and the feature control information element provides access control of the communication port. An example of the communication port is the port 122 of FIG. 1.

In some examples, the certificate received at the electronic device is signed by a private key associated with the access device, and the certificate issued by the certificate authority is based on a public key that is associated with the private key.

In some examples, the certificate includes expiry information indicating when the certificate expires.

In some examples, the controller 506 receives, from the access device, a message containing a timestamp, the message signed with a private key of the access device. The controller 506 uses the message as part of validating the certificate.

FIG. 6 is a block diagram of a non-transitory machine-readable or computer-readable storage medium 600 storing machine-readable instructions that upon execution cause an access device to perform various tasks. An example of the access device is the access device 104 of FIG. 1.

The machine-readable instructions include access request sending instructions 602 to send, from the access device to a CA, an access request associated with accessing a target electronic device to which the access device is connected. The access device may be connected to the target electronic device by a wired connection or a wireless connection. The access request can include a CSR containing a public key associated with the access device (or a user of the access device).

The machine-readable instructions include certificate reception instructions 604 to receive, at the access device from the CA, a certificate as a response to the access request, the certificate including a feature control information element that provides fine-grained access control of an electronic device feature of the target electronic device. The certificate may include multiple feature control information elements that provide fine-grained access control of respective multiple electronic device features of the target electronic device.

The machine-readable instructions include certificate signing instructions 606 to sign the certificate using a private key stored in the access device.

The machine-readable instructions include signed certificate sending instructions 608 to send the signed certificate to a controller in the target electronic device. The controller may include a BMC or another type of management controller.

The machine-readable instructions include access indication reception instructions 610 to receive, at the access device from the target electronic device, an indication of whether access to the electronic device feature is granted. The indication may be the accept indication sent at 220 in FIG. 2, or the reject indication sent at 224 in FIG. 2.

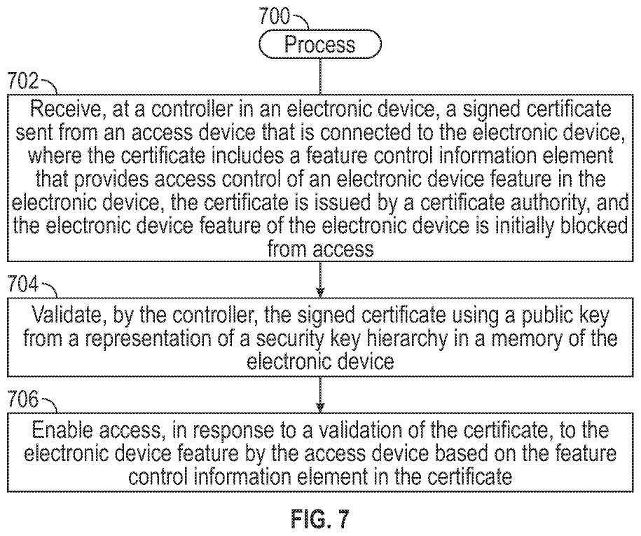

FIG. 7 is a flow diagram of a process 700, which may be performed by an electronic device.

The process 700 includes receiving (at 702), at a controller (e.g., 108 in FIG. 1) in the electronic device, a signed certificate sent from an access device that is connected to the electronic device. The certificate includes a feature control information element that provides access control of an electronic device feature in the electronic device, where the certificate is issued by a certificate authority, and the electronic device feature of the electronic device is initially blocked from access. The electronic device further includes a host processor (e.g., 110 in FIG. 1), separate from the controller, to execute primary machine-readable instructions of the electronic device.

The process 700 includes validating (at 704) the signed certificate using a public key from a representation of a security key hierarchy in a memory of the electronic device. The public key is included in a node of the security key hierarchy that represents the access device (or the user of the access device).

The process 700 includes enabling (at 706) access, in response to a validation of the certificate, to the electronic device feature by the access device based on the feature control information element in the certificate.

A “BMC” (e.g., the BMC 108 of FIG. 1) can refer to a specialized service controller that monitors the physical state of an electronic device using sensors and communicates with a remote management system (that is remote from the electronic device) through an independent “out-of-band” connection. The BMC can perform management tasks to manage components of the electronic device. Examples of management tasks that can be performed by the BMC can include any or some combination of the following: power control to perform power management of the electronic device (such as to transition the electronic device between different power consumption states in response to detected events), thermal monitoring and control of the electronic device (such as to monitor temperatures of the electronic device and to control thermal management states of the electronic device), fan control of fans in the electronic device, system health monitoring based on monitoring measurement data from various sensors of the electronic device, remote access to the electronic device (to access the electronic device over a network, for example), remote reboot of the electronic device (to trigger the computer system to reboot using a remote command), system setup and deployment of the electronic device, system security to implement security procedures in the electronic device, and so forth.

In some examples, the BMC can provide so-called “lights-out” functionality for an electronic device. The lights out functionality may allow a user, such as a systems administrator, to perform management operations on the electronic device even if an OS is not installed or not functional on the electronic device.

Moreover, in some examples, the BMC can run on auxiliary power provided by an auxiliary power supply (e.g., a battery); as a result, the electronic device does not have to be powered on to allow the BMC to perform the BMC's operations. The auxiliary power supply is separate from a main power supply that supplies powers to other components (e.g., a main processor, a memory, an input/output (I/O) device, etc.) of the electronic device.

A storage medium (e.g., 600 in FIG. 6) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An electronic device comprising:
a memory to store a representation of a security key hierarchy;
a controller to:
receive a certificate sent from an access device that is connected to the electronic device, the certificate comprising a feature control information element that provides access control of an electronic device feature of the electronic device, the certificate issued by a certificate authority, wherein the electronic device feature of the electronic device is initially blocked from access;
validate the certificate using the representation of the security key hierarchy in the memory; and
responsive to the validation of the certificate, enable access to the electronic device feature by the access device based on the feature control information element in the certificate.

2. The electronic device of claim 1, wherein the feature control information element is part of an object identifier (OID) in the certificate.

3. The electronic device of claim 2, wherein the OID comprises metadata, the metadata comprising the feature control information element settable to different values to indicate whether the electronic device feature is accessible.

4. The electronic device of claim 1, wherein the electronic device feature remains blocked from access in an absence of a valid certificate.

5. The electronic device of claim 1, wherein the electronic device feature comprises a communication port of the electronic device, and the feature control information element provides access control of the communication port.

6. The electronic device of claim 1, wherein the electronic device feature comprises a display device of the electronic device, and the feature control information element provides access control of the display device.

7. The electronic device of claim 1, wherein the electronic device feature comprises a power cycling subsystem or a boot mechanism of the electronic device, and the feature control information element provides access control of the power cycling subsystem or the boot mechanism.

8. The electronic device of claim 1, wherein the certificate is signed with a private key of the access device, and the controller is to:
validate the certificate based on decrypting the signed certificate using a public key obtained from the security key hierarchy.

9. The electronic device of claim 1, wherein the security key hierarchy comprises a public key infrastructure (PKI) tree.

10. The electronic device of claim 1, wherein the certificate received at the electronic device is signed by a private key associated with the access device, and the certificate issued by the certificate authority is based on a public key that is associated with the private key.

11. The electronic device of claim 1, wherein the enabling of the access to the electronic device feature based on the feature control information element in the certificate comprises unblocking access to the electronic device feature that is initially blocked.

12. The electronic device of claim 1, wherein the security key hierarchy comprises a hierarchical arrangement of keys associated with respective entities, the entities comprising the electronic device and a user authorized to access the electronic device.

13. The electronic device of claim 1, wherein the feature control information element if set to a first value disables access to the electronic device feature, and if set to a different second value enables access to the electronic device feature.

14. The electronic device of claim 1, wherein the certificate comprises expiry information indicating when the certificate expires.

15. The electronic device of claim 1, wherein the controller is to:
receive a message containing a timestamp, the message signed with a private key of the access device; and
use the message as part of validating the certificate.

16. A non-transitory machine-readable storage medium comprising instructions that upon execution cause an access device to:
send, from the access device to a certificate authority, an access request associated with accessing a target electronic device to which the access device is connected;
receive, at the access device from the certificate authority, a certificate as a response to the access request, the certificate comprising a feature control information element that provides access control of an electronic device feature of the target electronic device;
sign the certificate using a private key stored in the access device;
send the signed certificate to a controller in the target electronic device; and
receive, at the access device from the target electronic device, an indication of whether access to the electronic device feature is granted.

17. The non-transitory machine-readable storage medium of claim 16, wherein the indication is based on a validation of the signed certificate using a public key from a security key hierarchy represented in the target electronic device.

18. The non-transitory machine-readable storage medium of claim 17, wherein the validation of the signed certificate is performed by a management controller in the target electronic device, and the indication is received at the access device from the management controller.

19. A method comprising:
receiving, at a controller in an electronic device, a signed certificate sent from an access device that is connected to the electronic device, the certificate comprising a feature control information element that provides access control of an electronic device feature in the electronic device, the certificate issued by a certificate authority, wherein the electronic device feature of the electronic device is initially blocked from access, and wherein the electronic device further comprises a host processor, separate from the controller, to execute primary machine-readable instructions of the electronic device;
validating, by the controller, the signed certificate using a public key from a representation of a security key hierarchy in a memory of the electronic device; and
based on a validation of the signed certificate, enabling access to the electronic device feature by the access device based on the feature control information element in the certificate.

20. The method of claim 19, wherein the certificate comprises an X.509 certificate, and the feature control information element is in an object identifier (OID) of the X.509 certificate.
